(19) United States
(12) Patent Application Publication
(10) Pub. No.: US 2009/0249801 A1
(43) Pub. Date: Oct. 8, 2009

(54) COLD TRAP TO INCREASE GAS RESIDENCE TIME TO INCREASE CONDENSATION OF VAPOR MOLECULES

(76) Inventor: Herbert J. Hedberg, N. Attleboro, MA (US)

Correspondence Address: CESARI AND MCKENNA, LLP, 88 BLACK FALCON AVENUE, BOSTON, MA, 02210, US

(21) Appl. No.: 12/417,969

(22) Filed: Apr. 3, 2009

Related U.S. Application Data
(60) Provisional application No. 61/042,456, filed on Apr. 4, 2008.

(51) Int. Cl. B01D 8/00

(52) U.S. Cl. 62/55.5

(57) ABSTRACT

A cold trap is disclosed with a chamber having partitions or surfaces that direct the incoming wet vapor to substantially all of the cold inner surfaces of the cold trap. Typically, the cold inner surfaces are the inner walls of the chamber. The interaction of the wet vapor and the cold surfaces condense the molecules. The wet vapor minus the condensed molecules may be heated and returned to the source of the wet vapor for reuse. One example of the partitions or surfaces is a spiral inclined plane where the wet vapor flows along the spiral plane that acts to drive the wet vapor toward the cold inner walls of the chamber.

### CROSS REFERENCE TO RELATED APPLICATIONS

The present application is related to a provisional patent application filed Apr. 4, 2008, Ser. No. 61/042,456 entitled: “Design of Cold Trap to Increase Residence Time to Increase Condensation of Vapor Molecules,” and is of common ownership and inventorship. This provisional application is hereby incorporated herein by reference.

### BACKGROUND OF THE INVENTION

1. Field of the Invention

The present invention relates to removing vapor molecules from a gas, usually carbon dioxide or nitrogen, and more particularly to circulating the gas through a cold trap where the vapor molecules condense.

2. Background Information

Sample concentrators are prevalent in virtually all liquid processing operations. Materials of interest are typically synthesized, modified, and purified in solution-based process steps. To recover these dissolved non-volatile materials as dry powders and/or to increase the concentration of compounds; vacuum centrifuges, freeze drying, or blow down concentrators are used. These are terms that are well known and defined in the art.

Typically a cold trap is utilized in concentration systems to scavenge evaporated solvent molecules from the gas or vacuum as they move from the higher concentration space inside a sample container to the low concentration space inside a solvent collection vessel of the cold trap.

Vacuum concentrators and freeze dryers require a powerful vacuum pump to produce the low levels of ambient pressure necessary to promote the ejection and escape of solvent molecules from the surface of the solution. These solvent molecules migrate by diffusion to the lower concentration region of the cold trap solvent collection container and condense into ice. Once melted, this trapped solvent can be safely eliminated by an approved hazardous waste disposal company as a liquid.

Blow-down concentrators create a continuous flow of a small amount of gas onto the surface of the liquid solution. The gas flow promotes the escape of solvent molecules from the solution container so that they can be carried away in the flow of used gas out an exhaust port. A blow-down unit is typically located inside a fume hood so that solvent vapors are carried outside and not released to the workspace.

Recent practice and policy mandates that all reasonable effort be used to recover solvent vapors which could harm the environment. Habitual use of a fume hood to dispose of solvent vapors has become irresponsible. Wherever possible, evaporated solvent is condensed and recovered in a liquid state and, as mentioned above, safely disposed by an approved hazardous waste disposal company.

When a typical cold trap is configured with a blow-down concentrator, the evaporated solvent molecules are carried along in a gas flow measured in liters per minute. This results in poor yields of condensed vapor molecules due to the fast moving gas residing for too little time in the typical cold trap. Such systems are impractical.

When recovery is sought from a cold trap, the thermodynamics of the cold trap requires that sufficient opportunity exists for energy removal from the vapor molecules such that they can condense to a liquid. In vacuum systems, the vapor molecules migrate from the sample to the cold trap by diffusion, a process which is inherently slow and therefore well-matched to cold trap requirements for good performance. However, because vacuum systems provide little means to accelerate the escape of solvent molecules from the sample liquid, the overall evaporation process is far slower than that achieved with application of aggressive blow-down techniques.

### SUMMARY OF THE INVENTION

The present invention provides partitions or surfaces (used interchangeably herein) added to the inner chamber of a closed cold trap container. The partitions or surfaces create a lengthened path from inlet to outlet within the closed container. This increases the residence time of the “wet” vapor in the chamber providing more opportunity for the vapor molecules to condense through repeated contact with the chamber walls. “Wet” is defined as the incoming vapor comprising drying gas carrying solvent molecules that are to be removed (dried) from the incoming vapor.

Illustratively, the partitions or surfaces may form a spiral inclined plane where the wet vapor enters the partitioned path at or near the bottom of the chamber and circulates upward around the inside many times before exiting at the top. The exiting dry vapor may be heated and returned to and reused by the evaporation device producing the incoming “wet” vapor.

In other embodiments, the entry port may be distributed on the container from the top to the bottom, and the exit port may be likewise distributed from the top to the bottom, but the partitions or surfaces are arranged to form a path from the entry to the exit ports wherein the wet vapor interacts with substantially the entire cold surface area.

The present invention provides for an increased the path length of gas flow through a cold trap. The resulting increased residence time provides increased opportunity for vapor molecules in the gas to lose sufficient energy to condense in the trap whereby the vapor exiting the cold trap is drier than that entering. In one application the wet vapor is driven by the physical construction of the spiral surfaces toward the cold wall to increase the likelihood of condensing.

In other applications the partitions may include internal baffles that further lengthen the internal path of the vapor within the closed container cold trap.

### BRIEF DESCRIPTION OF THE DRAWINGS

The invention description below refers to the accompanying drawings, of which:

FIG. 1 is a drawing showing a system application with an example of the invention illustrated in cross section;

FIG. 2 is a perspective drawing of the spiral inclined plane of FIG. 1;

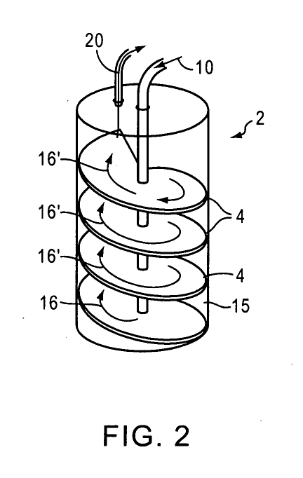

FIG. 3 is an assembly drawing showing the inclined plane insert, a liner that receives the insert and a volume within a mass of cold material to receive the liner and insert; and

FIG. 4 is an assembly drawing of the insert inside the liner about to be inserted into the volume.

### DETAILED DESCRIPTION OF AN ILLUSTRATIVE EMBODIMENT

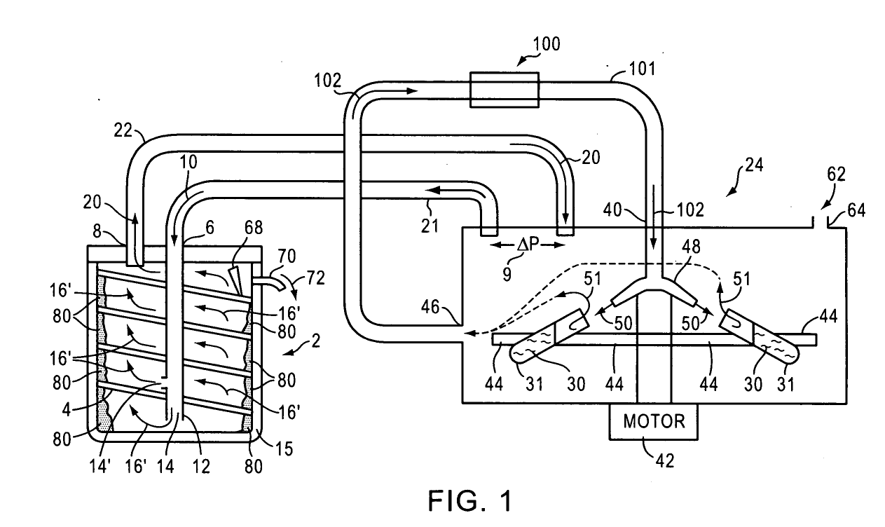

FIG. 1 includes a cold trap 2 with a vertical tube 12 leading to a bottom exit 14. Incoming flowing wet vapor 10 circulate 16′ up the spiral inclined plane 4 forming a path to an outlet 8. The gas flows 16′ from the opening 14 and hits the inner wall of the container 15 where it condensers 80. The wet vapor follows the spiral path 4 around the center tube 12 tracing a path (the 16's) to the outlet 8. The dry exiting gas flows 20 via the tube 22 back to the source 24 of the wet vapor. The outside of the container 15 is cooled and the solvent molecules in the wet vapor condense and solidify 80 along the inner side of the container 15. There may be other exits from the center above the lowest exit 14. These other exits may be smaller allowing less vapor to exit the center tube, but they allow the cold trap to operate when the exit 14 is effectively plugged by the condensed material 80.

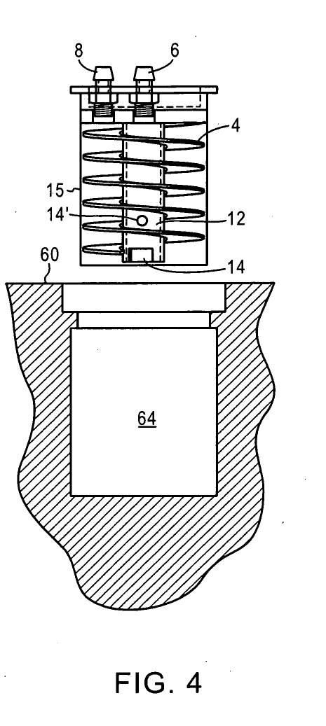

The spiral inclined plane 4 is made to abut the inner surface of the container 15, and the entire assembly 62 (FIG. 4) may be immersed in a cold material 60 or a volume 64 may be prepared in a cold material 60 into which assembly 62 (FIG. 4) is inserted. To increase the effectiveness, container 15 is made of a high thermal conductivity material, e.g. iron, steel, glass, etc.

An example of a source of wet vapor might be a centrifugal evaporator 24 as illustrated in FIG. 1. Other evaporators or the like may also be the source of wet vapors. In FIG. 1, the centrifugal evaporator is connected to the cold trap 2 by two tubes 22 and 21. The centrifugal evaporator has an entry port 25 and exit port 23 where gas flows 20 and 10 are caused by a low-pressure differential, ΔP 9 created by choice of attachment point above the spinning centrifuge rotor 44. The fan blades 44 are positioned to drive any gaseous content within the centrifuge 24 out the exit port 46 through a high-flow rate passage 101 thereby drawing in replacement gas from the port 40. The vapor flow 102 into the port 40 may pass through a heater 100 that enables the gas flowing into the evaporator centrifuge to hold more solvent molecules. That heated gas flow 102 is directed to a distribution assembly 48 that distributes the heated gas flow 50 into each test tube 31. That flow 50 picks up solvent molecules from each test tube 31 and the now wet vapor exits 51 the test tubes laden with solvent molecules. That “wet” vapor environment within the evaporator 24 and high flow rate circulation loop 101 is constantly diverted into hose 21 at inlet 23 by low-pressure differential 9 and directed to the cold trap 2 as the flow 10. In the cold trap 2 the solvent is condensed on the inner sides of the cold trap liner 15 for later removal. The dry gas exits the cold trap via port 8 and flow 20 back through hose 22 to inlet 25 of the evaporator centrifuge 24. The outer case 15 of the cold trap is cooled forcing the condensation.

In the centrifugal evaporator illustrated in FIG. 1, the design specifics maybe arranged where the high-vapor flow 102 rate is about 200 cfm (cubic feet per minute) and the flow 10 to the cold trap is about 5 cfm. In this configuration the cold trap is significantly more efficient than prior art example. For example, condensing water from the centrifugal evaporator environment warmed to 40° C. the present invention condenser 188 microliters per min compared to 33 to 57 microliters per minute from prior art evaporator-condenser systems. The present invention condensed 874 microliters per minute of MeOH compared to 125 to 200 microliters per minute for the prior art condenser-evaporator systems.

Although the vapor flow in FIG. 1 is from the bottom of the container 15 to the top, the flow might be reversed in some applications. Here the wet vapor may enter the top and be driven to an exit port near the bottom of the chamber. In yet other applications the entry and exit ports may be distributed virtually anywhere on the chamber, but the internal partitions and surfaces will direct the vapor flow along the entire inner surface of the chamber before exiting the cold trap.

The efficiency of the condensation process is dependent largely upon a sufficiently low temperature at the interior walls of the cold trap to condense or freeze the solvent molecules in the flow 10 and a sufficiently long cold trap residence time for the vapor-ladened gas 16′ circulating within the cold trap. Dried gas 20 at the outlet 8 of the cold trap travels back to the centrifugal evaporator 24 by connecting tube 22.

If the user desires a specific gas environment during the drying process or make up gas to balance inevitable losses, gas may be introduced into the system at port 64 resulting in gas-flow 62. Because this is necessarily a closed system to prevent the escape of solvent molecules from solutions 30, a vent fitting 70 is provided behind a baffle 68 in the cold trap 2. The rate of make-up gas-flow 62 will create an equal rate of vent gas-flow 72. Because gas-flow 72 could still contain some uncondensed solvent molecules, a hose should be connected between vent fitting 70 and a convenient chemical fume hood facility (not shown). A charcoal filter (not shown) or other solvent scrubber could be inserted between the vent and fume hood if desired.

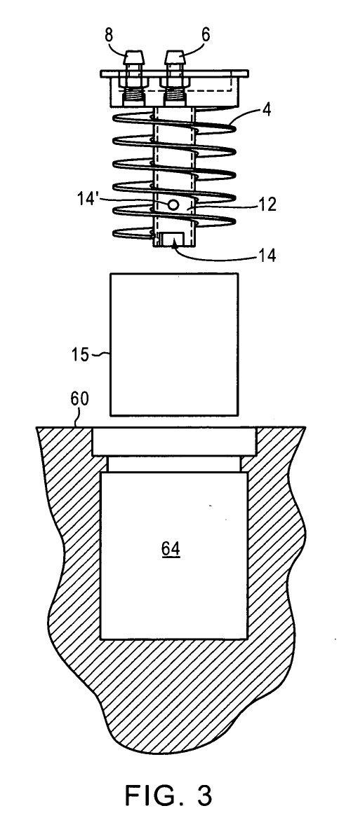

Referencing FIG. 3, the spiral inclined plane 12 may be a molded insert that is fitted into a liner 15, the liner forming the walls of a chamber inside the cooled container 60. The molded insert 12 and the liner 15 may then be inserted into the volume 64 formed in the cold material 60. FIG. 4 shows the molded insert 12 pressed into the liner 15 with the volume 64 in the cold material 60 waiting to receive the assembly 62.

To remove the frozen solvent 80 (FIG. 1) from inside the cold trap liner 15, when the canister is full of condensed solids 80 or the flow path becomes unacceptably blocked, the assembly 62 (FIG. 4) is lifted out of cold material 60 long enough to thaw the interface layer between spiral inclined plane 12 and liner 15. When the frozen material 80 (FIG. 1) releases from the liner 15, the insert 12 with the remaining frozen solvent 80 may be withdrawn from the liner 15. In this way a previously defrosted spiral insert 12 might be immediately inserted into the liner 15 and the assembly 62 inserted into the cold material 60 so that the solvent evaporation/concentration process might continue.

Alternatively, the tubes connecting to the inlet 6 and outlet 8 ports of the cold trap may be disconnected and connected directly to another cold trap that has no condensed material. The full cold trap may then be emptied and be ready for use when the replacement cold trap is full.

In the case of a concentrator system illustrated in FIG. 1 operating at atmospheric pressure, a common volume of gas is repeatedly pumped around a closed loop between the centrifugal system 24 and the cold trap 2. Because the transport mechanism of the wet vapor is not limited as to flow, the time spent in the cold trap volume might be significantly reduced if it were not for the spiral insert 12 that lengthen the path through the cold trap. The circular path 4 used to guide the gas flow 16′ also imparts a centrifugal force driving the heavier solvent to the outside of the circular path. This property greatly increases the condensation rate within the trap as compared with an empty trap canister with no spiral inclined plane insert.

There may be other baffles along the spiral inclined plane to direct the vapor flow closer to the inner wall of the cooled canister 15 to promote condensation. Moreover, the slope (or pitch) of the incline 4 on all FIGs (the distance between the spirals) may be determined heuristically depending on the application.

It should be understood that above-described embodiments are being presented herein as examples and that many variations and alternatives thereof are possible. Accordingly, the present invention should be viewed broadly as being defined only as set forth in the hereinafter appended claims.

1. A cold trap comprising:
a chamber enclosed by a wall defining an inner surface, the wall made from a high thermal conductivity material;
an entry port where wet vapor is introduced;
a surface constructed within the chamber to accept the entering wet vapor and direct the wet vapor toward and around the periphery of the inner surface; wherein the molecules may condense on the inner surface; and
an exit port where the vapor minus the condensed molecules exits the cold trap.

2. The cold trap of claim 1 wherein the inner surface comprises a spiral inclined plane defining a flow path from the entry to the exit ports, wherein the wet vapor circulates around the spiral inclined plane, and wherein the flow path along the spiral inclined plane acts to drive the vapor toward the inner surface.

3. The cold trap of claim 2 wherein the entry port is located near the bottom of the chamber and the inclined plane leads from the bottom to the top of the chamber, and the exit port is located near the top of the chamber.

4. The cold trap of claim 2 further comprising a central tube running from the top to the bottom of the chamber, wherein the entry port is connected to the central tube at the top of the chamber, and
at least one opening near the bottom of the central tube where the wet vapor entering the entry port travels to the at least one opening and travels up the spiral inclined plane to the exit port.

5. The cold trap of claim 1 wherein the entry and exit ports are located somewhere on the wall enclosing the chamber, wherein the partitions within the chamber direct the incoming wet vapor to contact substantially the entire inner surface before exiting.

6. A method for drying wet vapor, the method comprising the steps of:
driving the wet vapor into a chamber with a cold inner surface,
within the chamber driving the wet vapor to contact substantially the entire cold inner surface wherein molecules in the wet vapor condense on the cold inner surface and
the vapor minus the condensed molecules exiting the chamber.

7. The method of claim 6 wherein the step of driving the wet vapor to contact substantially the entire cold inner surface comprises the step of spirally circulating the wet vapor along a spiral inclined plane leading from an entry port to an exit port, and
driving the wet vapor toward the cold inner surface.

8. The method of claim 7 further comprising the steps of:
delivering the wet vapor to an entry ports near the bottom of the chamber and circulating the wet vapor along an inclined plane from the bottom to the top of the chamber, and
the vapor minus the condensed molecules exiting near the top of the chamber.

9. The method of claim 7 further comprising the step of driving the wet vapor into the top of a central tube running from the top to the bottom of the chamber,
exiting the central tube from at least one opening near the bottom of the chamber wherein the wet vapor travels up the spiral inclined plane to the exit port.
